(19) United States
(12) Patent Application Publication
(10) Pub. No.: US 2007/0208622 A1
(43) Pub. Date: Sep. 6, 2007

(54) PROMOTIONAL METHODS INVOLVING THE USE OF TOKENS

(76) Inventor: Karen Nixon Lane, Plymouth, MI (US)

Correspondence Address: BUTZEL LONG, 350 SOUTH MAIN STREET, SUITE 300, ANN ARBOR, MI, 48104, US

(21) Appl. No.: 11/677,119

(22) Filed: Feb. 21, 2007

Related U.S. Application Data
(60) Provisional application No. 60/775,190, filed on Feb. 21, 2006.

(51) Int. Cl. G07G 1/14

(52) U.S. Cl. 705/14

(57) ABSTRACT

A business method of promoting commercial activity and goodwill in a municipality which involves identifying consumers to be attracted to participate in commercial activity within a municipality, distributing at least one token to each of the identified consumers, allowing the consumers to exchange the tokens for discount cards that have a predetermined dollar discount value for commercial activity within a municipality; allowing the consumers to purchase goods and/or services from merchants within the municipality; and having the merchants from which goods and/or services are purchased discount the purchase price and deduct the discounted amount from the predetermined dollar discount value of the consumers' discount cards. The tokens can also be provided with serialized data which can be collected and recorded when the tokens are distributed and exchanged. The data can be used to determine and develop marketing strategies based on the manner in which the tokens were distributed and dispersed.

### TECHNICAL FIELD

The present invention relates to business methods for promoting goodwill and commercial activities in municipalities. More particularly, the present invention relates to the use of data serialized tokens and their use in promotional business and marketing methods.

### BACKGROUND

While retail shops and stores typically offer and promote sales using newspaper advertisements, fliers, mailings, in store displays, etc., such manners of promoting commercial activity is often limited to, or only effective in, generating commercial activity within the local municipality. In such a situation, while the shops and stores may benefit, the municipality does not really benefit financially, since only local money is circulated.

Also, the use of newspaper advertisements, fliers, mailings, in store displays, etc., lack the ability to track, accumulate and process data that is related to the success of such promotions. Commercial enterprises may track the general increase in activity following a promotion or request and collect general information such as zip codes or phone numbers from consumers after a promotion. However, the ability to accurately to track, accumulate and process data that is related to the success of such promotions is unfulfilled.

The present invention provides a method for generating commercial activity within a municipality, such as a town, city, community which attracts consumers from outside the municipality, while at the same time generating goodwill for the municipality.

### DISCLOSURE OF THE INVENTION

According to various features, characteristics and embodiments of the present invention which will become apparent as the description thereof proceeds, the present invention provides a method of promoting a commercial activity within a municipality which involves the steps of:

a) providing at least one token to each of a plurality of consumers;

b) allowing the consumers to exchange the tokens for discount cards that have a predetermined dollar discount value for commercial activity within a municipality;

c) allowing the consumers to purchase goods and/or services from merchants within the municipality; and

d) having the merchants from which goods and/or services are purchased in step c) discount the purchase price and deduct the discounted amount from the predetermined dollar discount value of the consumers' discount cards.

The present invention further provides a method of promoting a commercial activity which comprises the steps of:

a) providing at least one token to each of a plurality of consumers, each token provided with serialized data;

b) allowing the consumers to exchange the tokens for discount cards that have a predetermined dollar discount value for commercial activity within a municipality;

c) allowing the consumers to purchase goods and/or services from merchants within the municipality,

d) having the merchants from which goods and/or services are purchased in step c) discount the purchase price and deduct the discounted amount from the predetermined dollar discount value of the consumers' discount cards; and

e) recording the serialized data provided on the tokens exchanged in step b) and correlating information regarding the distribution and collection of the individual tokens,

### BEST MODE FOR CARRYING OUT THE INVENTION

The present invention is directed to data serialized tokens and their use in promotional business methods. According to one aspect of the present invention the serialized tokens are used in a business method for motivating potential and/or repeat consumers outside a municipality to engage in commercial activities within the municipality, including shopping, dining, entertainment, etc. The method involves providing potential and/or repeat consumers outside the municipality with tokens which can be exchanged for discount cards that have a predetermined dollar discount value for commercial activity within the municipality. The tokens further include identification data incorporated thereon and/or therein. Such tokens can be provided to potential and/or repeat consumers through any type of promotional offering sponsored by the municipality and/or corporate sponsors, including but not limited to, mailings which include the tokens, vacation and/or travel packages in which the tokens are provided by travel agents, airlines, etc., promotional events such as sporting events, store events and the like in which the tokens are given to potential and/or repeat consumers, and other promotional methods and activities. Alternatively, the tokens can be purchased directly by the consumers, in which case the municipality can generate income from the sales of the tokens.

The tokens have a predetermined “discount dollar value” inasmuch as they can be exchanged for discount cards that have a predetermined dollar discount value for commercial activity within the municipality. For example a consumer may obtain a token for which the consumer, the municipality or a corporate sponsor invested ten dollars ($10). The consumer then exchanges the token for a discount card that has a discount dollar value of one hundred dollars ($100). The discount value of the discount card is realized by the consumer when purchases are made within the municipality at participating merchants that will offer percentage discounts on purchases of goods and services and deduct the discount amount from the discount dollar value or remaining discount dollar value of the discount card. When the discount dollar value of the card is depleted, the consumer has to obtain a new token if he or she wants to continue to participate in the program. The cost of the tokens and the discount value of the discount card can be varied as desired. Likewise, the participating merchants can offer various discount percentages on purchases and services.

The tokens can be exchanged for the discount cards by any convenient manner, including providing vending-type exchange machines or over-the-counter exchange facilities. Ideally, the tokens are exchanged within the municipality when the consumer visits the municipality in order to spur goodwill and commercial activity.

For the municipality, the cost or initial value of the tokens (to give them to consumers rather than sell them to consumers), can be offset by corporate sponsors who, in exchange for paying the municipality for the cost or initial value, can have their corporate logo or advertisement produced on the tokens. Likewise, the municipality can have its own promotional logo or advertisement on the tokens.

The tokens can be distributed and give out in a variety of packaging designs for any particular promotional event or theme. According to one aspect of the present invention a variety of tokens can be provided in a variety of packaging designs, to suit different themes, holidays, casinos, etc.

The tokens are provided with serialized data which allows the circulation and use of the tokens to be tracked or monitored either manually or electronically, using for example, the apparatus for detecting, processing, collecting, and managing serialization data applied to tokens as discussed in applicant's copending U.S. patent application Ser. No. 11/104,585, which is expressly incorporated herein by reference.

The serialized data can be used for the collection of marketing feedback data based upon promotion-encoded tokens that can be distributed to consumers and then collected. Other applications can be based upon using the collected data in any manner such as, for example, tracking commercial activity as a function of various variables such as economy, geographic populace, etc. Similar applications involve the collection of data and the determination therefrom of the success of a promotional method that involves distribution of the tokens.

Using a standard manufacturing method, metallic tokens can be produced according to the present invention which will have unique serial number or batch data applied to one or more areas. The data may be applied by a number of processes depending upon the style, material, or aesthetics of design. Stamping, raised, color or color patterns, hot-stamping, pin-stamping are all non-limiting examples of possible methods well-understood in manufacturing.

It is not necessary for the data to be numeric in nature. It must simply be capable of representing the detail resolution required by the end consumer. Various machine readable coding techniques are available including hexadecimal, base ten, graphic, gray encoding, binary, etc. If batch data is the highest level required, then simple graphic design features can be utilized to categorize the token.

Any material such as plastic, cast metal, stamped metal, or forged metals or metallic alloys, wood, etc. can be used to produce tokens for purposes of the present invention. In addition, any overall or patterned color or surface texture can be applied or provided on the tokens.

As noted herein the tokens can be made from metal, metal laminates, plastic materials, wood, etc. As used herein “tokens” encompasses various coin-type pieces that may or may not have a face or cash value. Further as used herein “tokens” can include non-coin-type tokens which can have shapes other than round coin shapes and even card shapes. The only requirement for such non-coin-type tokens is that they are provided with serialized data and that they are sufficiently durable to be distributed, circulated, collected and preferably re-distributed, re-circulated, recollected more than once.

The discount card can be made of plastic materials, paper, laminate or composite materials or any suitable materials. Preferably the discount cards are provided with a magnetic strip or other media which can store information such as the dollar discount value. The use of a magnetic strip or other media can allow the merchants to update the remaining balance of the dollar discount value using a card reader/writer in a known manner. It is also possible to print the remaining balance of the dollar discount value on the discount card or punch or mark the dollar discount card in some manner which indicates the remaining balance of the dollar discount value.

Alternatively to using discount cards that have a magnetic strip or other media which can store information such as the dollar discount value, the discount cards can be configured to be punched, tom, stamped or in some other fashion manually or mechanically marked to indicate the spent or consumed dollar discount value.

As in the case of the tokens, the discount cards can include advertisement for the municipality, corporate sponsor(s), participating merchants, charitable organizations, etc.

Likewise, the discount cards, are not limited to a conventional card shape, but can be any of any convenient shape. Moreover, the discount cards can be provide with serialized data that can be collected and or tracked when the cards are used to analyze and develop marketing and promotional information.

While the invention has been described in reference to municipalities issuing the tokens and participating merchants in the municipalities offering to accept the discount cards, it is to be understood that the tokens can be issued and accepted by any group or participating merchants that may or may not be limited to being within a close geographical area or site. For example the tokens can be issued and accepted by a participating group of merchants that are within a given shopping mall, strip mall, along a given avenue, within a general shopping area, etc. Merchants in this context include any commercial business that offers and sells goods, products, services, entertainment, etc. to consumers.

It is also to be understood that while the discount cards have been presented in combination with use of the tokens, it is within the scope of the present invention, according to one aspect thereof, to merely have the municipalities or participating group or merchants discussed above, provide the discount cards which can be provided to or sold to consumers and accept the discount cards as discussed above when the consumers engage in commercial activity within the municipality or with the participating group of merchants. The discounts cards would be unique because of their predetermined dollar discount value for commercial activity, and could be supported, funded, and/or distributed or sold by corporate sponsors, charitable organizations or for findraising purposes by various organizations.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above and set forth in the attached claims.

What is claimed is:

1. A method of promoting a commercial activity within a municipality which comprises the steps of:
a) providing at least one token to each of a plurality of consumers;
b) allowing the consumers to exchange the tokens for discount cards that have a predetermined dollar discount value for commercial activity within a municipality;
c) allowing the consumers to purchase goods and/or services from merchants within the municipality; and
d) having the merchants from which goods and/or services are purchased in step c) discount the purchase price and deduct the discounted amount from the predetermined dollar discount value of the consumers' discount cards.

2. A method of promoting a commercial activity within a municipality according to claim 1, wherein the distributed tokens further are provide with serialized data and the method further includes the step of collecting the tokens in step b), recording the serialized data provided on the collected tokens and correlating information regarding the distribution and collection of the individual tokens.

3. A method of promoting a commercial activity within a municipality according to claim 1, further comprising providing advertisement on at least one of the tokens and the discount cards.

4. A method of promoting a commercial activity within a municipality according to claim 1, further comprising updating a remaining dollar discount value of the discount cards in step d).

5. A method of promoting a commercial activity within a municipality according to claim 1, wherein the goods and/or services in step c) includes entertainment activities.

6. A method of promoting a commercial activity within a municipality according to claim 1, wherein in step a) the tokens are sold to the consumers.

7. A method of promoting a commercial activity within a municipality according to claim 1, wherein in step a) the tokens are given to the consumers and paid for by one of the municipality or a corporate sponsor.

8. A method of promoting a commercial activity which comprises the steps of:
a) providing at least one token to each of a plurality of consumers, each token provided with serialized data;
b) allowing the consumers to exchange the tokens for discount cards that have a predetermined dollar discount value for commercial activity within a municipality;
c) allowing the consumers to purchase goods and/or services from merchants within the municipality;
d) having the merchants from which goods and/or services are purchased in step c) discount the purchase price and deduct the discounted amount from the predetermined dollar discount value of the consumers' discount cards; and
e) recording the serialized data provided on the tokens exchanged in step b) and correlating information regarding the distribution and collection of the individual tokens.

9. A method of promoting a commercial activity within a municipality according to claim 8, further comprising providing advertisement on at least one of the tokens and the discount cards.

10. A method of promoting a commercial activity within a municipality according to claim 8, further comprising updating a remaining dollar discount value of the discount cards in step d).

11. A method of promoting a commercial activity within a municipality according to claim 8, wherein the goods and/or services in step c) includes entertainment activities.

12. A method of promoting a commercial activity within a municipality according to claim 8, wherein in step a) the tokens are sold to the consumers.

13. A method of promoting a commercial activity within a municipality according to claim 8, wherein in step a) the tokens are given to the consumers and paid for by one of the municipality or a corporate sponsor.
